(19) United States
(12) Patent Application Publication
(10) Pub. No.: US 2015/0202708 A1
(43) Pub. Date: Jul. 23, 2015

(54) IMAGE-INSPECTION APPARATUS AND IMAGE-INSPECTION METHOD FOR WELDED PORTION

(71) Applicant: TOYOTA JIDOSHA KABUSHIKI KAISHA, Toyota-shi (JP)

(72) Inventors: Takehiro AOKI, Miyoshi-shi (JP); Yutaka MASUGI, Toyota-shi (JP); Seiya FUJIKI, Kiyosu-shi (JP)

(21) Appl. No.: 14/600,382

(22) Filed: Jan. 20, 2015

(30) Foreign Application Priority Data
Jan. 22, 2014 (JP) 2014-009818

(51) Int. Cl. B23K 9/095

(52) U.S. Cl. CPC B23K 9/0953; B23K 9/0956

(57) ABSTRACT

Disclosed are an image-inspection apparatus and an image-inspection method for a welded portion, capable of certainly pinpointing a joining interface of the welded portion. An image-inspection apparatus (100) for inspecting condition of a welded portion (W) where rectangular copper wires (21 and 22) are welded to each other, including a first camera (51) for taking an image of the welded portion (W) from a tangential direction, a second camera (52) for taking an image of the welded portion (W) from the radial outside, and a controller (50). The controller (50) pinpoints a position of a joining interface (J) from the image taken from the tangential direction, calculates a width of a welding ball (B) at the pinpointed position from the image taken front the radial outside, and inspects the condition of the welded portion (NV) based on the calculated width.

### TECHNICAL FIELD

The present invention relates to an image-inspection apparatus and an image-inspection method for inspecting, by use of images, condition of is welded portion where rectangular copper wires constituting a stator coil are welded to each other.

### BACKGROUND ART

A rectangular copper wire having a rectangular cross-section is used as a copper IN'ire of a stator coil of a large-sized motor in a process for producing the large-sized motor, rectangular copper wires are joined together by TIG welding, and the stator coil is produced (see Patent Literature 1, for example). A welded portion formed by joining the rectangular copper wires together by TIG welding needs to have an inspection on the condition thereof such as strength and joining area (conductive property) of the welded portion.

Conventionally, the following is known as a means for inspecting the condition of the welded portion: taking images of the welded portion to pinpoint a position of as joining interface (surface where first and second rectangular copper wires come in contact with each other during the welding) of the welded portion from the images, and then inspecting the condition of the welded portion based on a width of a welding ball (welding width) in the joining interface.

Note that the welding ball is spherically formed by solidification of a molten base material.

Moreover, conventionally, the following is known as a means for pinpointing the position of the joining interface from the taken images: pinpointing the position of the joining interface from the shape of the welding ball in the image, or pinpointing the position of the joining interface on the basis of a position of a part (horizontally curved part of a covered part of the rectangular copper wire) behind the welded portion in the image.

However, the means for pinpointing the position Of the joining interface from the shape of the welding ball may erroneously pinpoint the position of the joining interface if the welding ball is misshapen. On the other hand, the means for pinpointing the position of the joining interface on the basis of the position of the horizontally curved part of the covered part of the rectangular copper wire may erroneously pinpoint the position of the joining interface if the shape of the rectangular copper wire changes even a little for example.

### CITATION LIST

### Patent Literature

Patent Literature 1: JP 2013-121615 A

### SUMMARY OF INVENTION

### Problem to Be Solved By the Invention

The objective or the present invention is to provide an image-inspection apparatus and an image-inspection method for a welded portion, capable of certainly pinpointing as joining interface of the welded portion.

Means for Solving the Problem

The problem to be solved by the present invention is described above, and means for solving the problem are described below.

A first aspect of the present invention is an image-inspection apparatus for a welded portion, which inspects, using images of the welded portion, condition of the welded portion where rectangular copper wires constituting is stator coil, which are adjacently arranged are welded to each other, including a first camera for taking an image of the welded portion from a first direction, a second camera for taking an image of the welded portion from a second direction different from the first direction, and a controller for inspecting the condition of the welded portion based on a width of a welding bail in a joining interface between the rectangular copper wires in the welded portion. The controller pinpoints a position of the joining interface from the image of the welded portion taken from the first direction. The controller calculates the width of the welding ball at the pinpointed position of the joining interface from the image of the welded portion taken from the second direction. The controller inspects the condition of the welded portion based on the calculated of the welding ball in the joining interface.

A second aspect of the present invention is an image-inspection method for a welded portion, in which condition of the welded portion where rectangular copper wires constituting a stator coil, which are adjacently arranged are welded to each other is inspected using images of the welded portion, including taking an image of the welded portion from a first direction, pinpointing a position of a joining irate face between the rectangular copper wires from the image of the welded portion taken from the first direction, taking an image of the welded portion from a second direction different from the first direction, calculating a width of a welding ball at the pinpointed position of the joining interface from the image of the welded portion taken from the second direction, and inspecting the condition of the welded portion had on the calculated width of the welding ball in the joining interface.

### Effects of the Invention

An image inspection apparatus and an image-inspection method for a welded portion according to the present invention make it possible to certainly pinpoint a joining interface of the welded portion.

### BRIEF DESCRIPTION OF DRAWINGS

FIG. 1 shows configuration of an image-inspection apparatus.

FIG. 2 is a flowchart of an image-inspection method.

### DESCRIPTION OF EMBODIMENTS

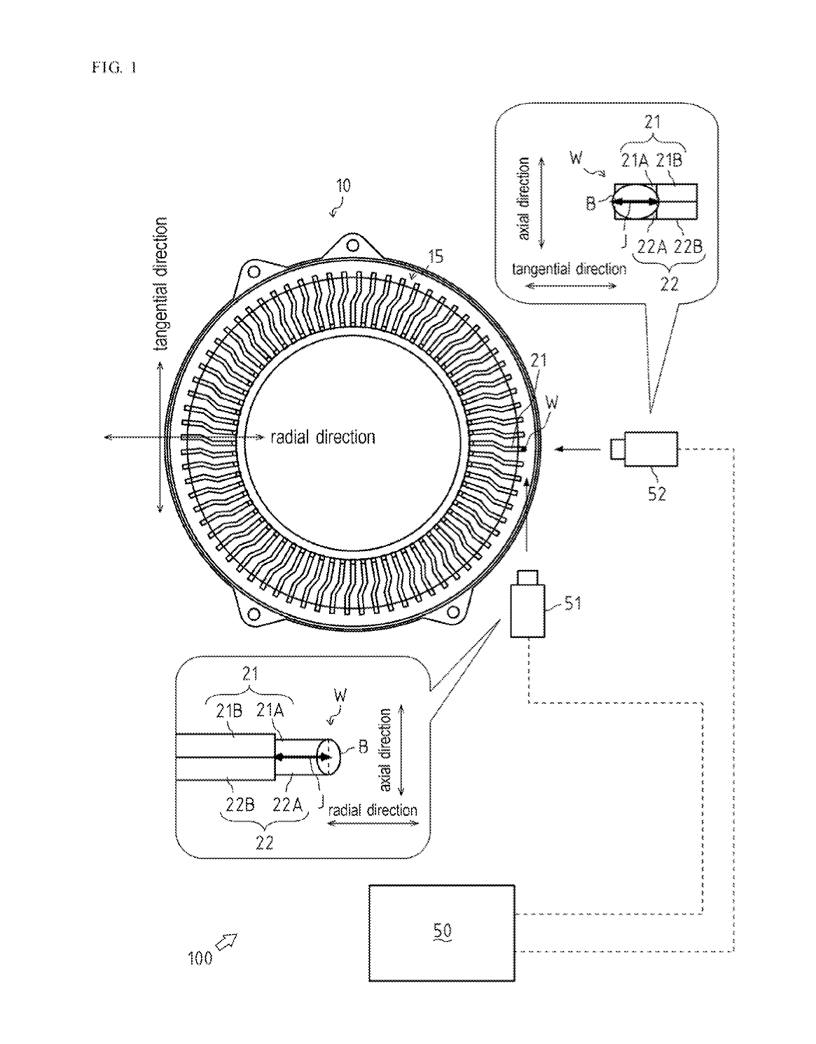

With reference to FIG. 1, configuration of image-inspection apparatus 100 is described below.

FIG. 1 schematically shows the configuration of the image-inspection apparatus 100. The broken lines in FIG. 1 represent electric signal lines. In each of the balloons from a first camera 51 and a second camera 52 in FIG. 1, an image of a welded portion W taken thereby is shown. A radial direction, a tangential direction, and an axial direction are defined as shown in FIG. 1.

The image-inspection apparatus 100 is an embodiment of an image-inspection apparatus for a welded portion according to the present invention. The image-inspection apparatus 100 inspects, using images of the welded portion W, condition of the welded portion W where rectangular copper wires 21 and 22 constituting a stator coil 15, which are arranged adjacently in the axial direction are welded to each other.

The stator coil 15 is one of the parts constituting a stator (not shown) of a motor 10, and constitutes the stator with a stator core (not shown). In the present embodiment, the stator coil 15 constitutes the stator in the shape of a substantially cylinder. The stator coil 15 consists of a plurality of rectangular copper wires.

The rectangular copper wire is a copper wire Whose section has a rectangular shape. In the present embodiment, the stator coil 15 has the rectangular copper wires 21 and 22 adjacent to each other in the axial direction in the upper end surface of the stator coil 15 in the shape of a substantially cylinder, the rectangular copper wires 21 and 22 extending outward in the radial direction.

In the rectangular copper wires 21 and 22 adjacent to each other, the rectangular copper wire 21 is arranged the upper side, and the rectangular copper wire 22 is arranged the lower side. A plurality of pairs of the rectangular copper wires 21 and 22 adjacent to each other are provided at different position in a circumferential direction, and are radially arranged. In the stator coil 15 in the present embodiment, the outer ends of the rectangular copper wires 21 and 22 adjacent to each other in the axial direction are welded to each other from the radial outside by TIG welding, and thereby the welded portion W is formed.

The rectangular copper wire 21 has a covered part 21B and a peeled part 21A. The rectangular copper wire 22 has a covered part 228 and is peeled part 22A. Each of the covered parts 21B and 22B is a part in which a copper wire is covered with a covering material. Each of the peeled parts 21A and 22A is a part in which the covering material is peeled to expose the copper wire.

The welded portion W is formed by welding the tips of the peeled parts 21A and 22A in the radial direction (ends of the peeled parts 21A and 22A, situated at the outer circumferential side) by TIG welding. Specifically, the tips of the peeled parts 21A and 22A in the radial direction are molten, and thereby a welding ball B is formed.

The welding ball B is spherically formed by solidification of the molten peeled parts 21A and 22A.

In the welded portion W, the peeled parts 21A and 22A are brought in contact with each other to form a joining interface J, and the tips of the peeled parts 21A and 22A in the radial direction are welded. In other words, the joining interface is a surface where the peeled parts 21A and 22A come in contact with each other in the welded portion W when joining the peeled parts 21A and 22A together.

The image-inspection apparatus 100 includes the first camera 51, the second camera 52, and a controller 50.

The first camera 51 takes an image of the welded portion W of the stator coil 15 from the tangential direction (direction perpendicular to a direction in which the rectangular copper wires 21 and 22 extend). The second camera 52 takes an image of the welded portion W of the stator coil 15 from the outside in the radial direction (direction in which the rectangular copper wires 21 and 22 extend). The first camera 51 and the second camera 52 are connected to the controller 50.

The controller 50 has capability to inspect the condition of the welded portion W based on a width of the welding ball B in the joining interface J of the welded portion W. In addition, the controller 50 has capability to obtain the images from the first camera 51 and the second camera 52 to analyze the images.

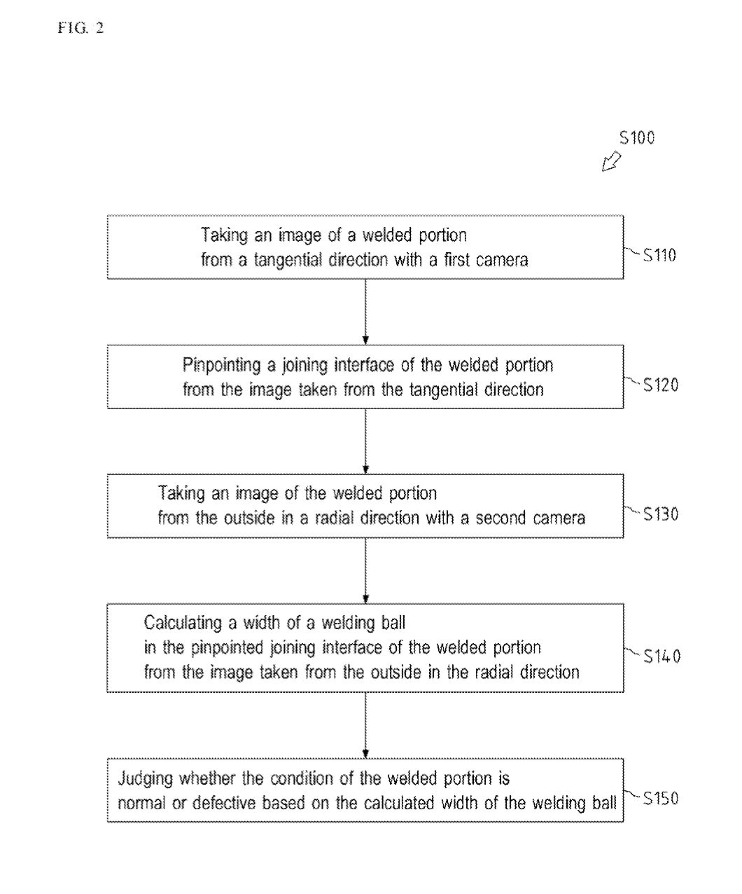

With reference to FIG. 2, a flow of an image-inspection step S100 is described below.

FIG. 2 is a flowchart of the image-inspection step S100.

The image-inspection step S100 is an embodiment of an image-inspection method for a welded portion according to the present invention.

The image-inspection step S100 includes inspecting, by use of the images of the welded portion W, the condition of the welded portion W where the rectangular copper wires 21 and 22 constituting the stator coil 15 are welded to each other. In a step S110, the controller 50 causes the first camera 51 to take an image of the welded portion W from the tangential direction (see FIG. 1)

In a step S120, the controller 50 analyzes the image taken in the tangential direction by the first camera 51, and pinpoints the axial position of the joining interface J of the welded portion W from the image taken from the tangential direction.

In the image of the welded portion W taken from the tangential direction, the tips of the peeled parts 21A and 22A in the radial direction are welded by TIG welding, but the surface (joining interface J) where the portions of the peeled pans 21A and 22A, which are situated on the radial inside of the welding ball B come in contact with each other is exposed. The controller 50 analyzes the image taken from the tangential direction, and pinpoints the axial position of the exposed joining interface J from the image.

In a step S130, the controller 50 causes the second camera 52 to take an image of the welded portion W from the radial outside (see FIG. 1).

In a step S140, the controller 50 analyzes the image taken from the radial outside by the second camera 52, and calculates the width of the welding ball B in the joining interface J of the welded portion W from the radial outside.

In the image of the welded portion W taken from the radial outside, since the tips of the peeled parts 21A and 22A in the radial direction are welded by TIG welding, it is difficult to recognize the axial position of the joining interface J. Therefore, the width of the welding ball B is calculated by utilizing the axial position of the joining interface J pinpointed in the step S120. Specifically, the width of the welding ball B at the axial position of the joining interface J pinpointed in the step S120 is calculated.

In a step S150, the controller 50 inspects the condition of the welded portion W based on the width of the welding ball B in the joining interface J. Specifically, the controller 50 judges the condition of the welded portion W to be normal when the calculated width of the welding ball B is larger than a standard width. On the other band, the controller 50 judges the condition of the welded portion W to be defective when the calculated width of the welding ball B is the standard width or less.

The effects of the image-inspection apparatus 100 and the image-inspection step S100 are described below.

The image-inspection apparatus 100 and the image-inspection step S100 make it possible to certainly pinpoint the joining interface J of the welded portion W. In addition, the image-inspection apparatus 100 and the image-inspection step S100 make it possible to certainly pinpoint the joining interface J of the welded portion W, and to calculate the width of the welding ball B at the axial position of the joining interface J. Consequently, it is possible to certainly judge, based on the width of the welding ball B, whether the condition of the welded portion W is normal or defective.

In other words, the image-inspection apparatus 100 and the image-inspection step S100 make it possible to certainly pinpoint the joining interface is of the welded portion W by taking an image of the welded portion W from the tangential direction to pinpoint the joining interface 1 exposed on the radial inside of the welding ball B.

In the image-inspection apparatus 100 and the image-inspection step S100 in the present embodiment, the first camera 51 takes an image of the welded portion W from the tangential direction, but there is no limitation to this. For example, the first camera 51 may take an image of the welded portion W from an inclined direction which is at a slight angle with the tangential direction.

In the image-inspection apparatus 100 and the image-inspection step S100 in the present embodiment, the two rectangular copper wires 21 and 22 are welded, but there is no limitation to this. Even if three rectangular copper wires are welded for example, similar effects can he produced.

In the image-inspection apparatus 100 and the image-inspection step S100 in the present embodiment, the welded portion W is inspected with two cameras, namely, the first camera 51 and the second camera 52, but there is no limitation to this. For example, the welded portion W may be inspected with three cameras which take images in different directions.

In the image-inspection apparatus 100 and the image-inspection step S100 in the present embodiment, the first camera 51 and the second camera 52 take images of the welded portion W formed at the tips of the rectangular copper wires 21 and 22 extending in the radial direction in order to inspect the welded portion W, but there is no limitation to this. For example, the first camera 51 and the second camera 52 may take images of the welded portion W formed at the tips of the rectangular copper wires 21 and 22 extending in the axial direction in order to inspect the welded portion W.

### REFERENCE SIGNS LIST

10: motor

15: stator coil

21: rectangular copper wire

22: rectangular copper wire

50: controller

51: first camera

52: second camera

100: image-inspection apparatus

W: welded portion

J: joining interface

B: welding ball

1. An image-inspection apparatus for a welded portion, which inspects, using images of the welded portion, condition of the welded portion where rectangular copper wires constituting a stator cod, which are adjacently arranged are welded to each other, comprising:
a first camera for taking an image of the welded portion from a first direction;
a second camera for taking an image of the welded portion from a second direction different from the first direction; and
a controller for inspecting the condition of the welded portion based on a width of a welding ball in a joining interface between the rectangular copper wires in the welded portion, wherein
the controller pinpoints a position of the joining interface from the image of the welded portion taken from the first direction,
the controller calculates the width of the welding ball at the pinpointed position of the joining interface from the image of the welded portion taken from the second direction, and
the controller inspects the condition of the welded portion based on the calculated width of the welding ball in the joining interface.

2. An image-inspection method for a welded portion, in which condition of the welded portion where rectangular copper wires constituting a stator coil, which are adjacently arranged are welded to each other is inspected using images of the welded portion, comprising:
taking an image e welded portion from a first direction;
pinpointing a position of a joining interface between the rectangular copper wires from the image of the welded portion taken from the first direction;
taking an image of the welded portion from a second direction different from the first direction:
calculating a width of a welding ball at the pinpointed position of the joining interface from the image of the welded portion taken from the second direction; and
inspecting the condition of the welded portion based on the calculated width of the welding ball in the joining interface.
